(19) United States
(12) Patent Application Publication
(10) Pub. No.: US 2013/0258485 A1
(43) Pub. Date: Oct. 3, 2013

(54) GLASS LENTICULARS FOR AUTOSTEREOSCOPIC DISPLAY

(71) Applicants: Heather D. Boek, Corning, NY (US); Robert A. Boudreau, Corning, NY (US); Thierry L.A. Dannoux, Avon (FR); Jacques Gollier, Painted Post, NY (US); Mark O. Weller, Painted Post, NY (US)

(72) Inventors: Heather D. Boek, Corning, NY (US); Robert A. Boudreau, Corning, NY (US); Thierry L.A. Dannoux, Avon (FR); Jacques Gollier, Painted Post, NY (US); Mark O. Weller, Painted Post, NY (US)

(21) Appl. No.: 13/431,255

(22) Filed: Mar. 27, 2012

(51) Int. Cl. C03B 23/02; G02B 3/00

(52) U.S. Cl. CPC C03B 23/02; G02B 3/005
USPC 359/619; 65/102; 65/60.1; 65/60.3; 65/286

(57) ABSTRACT

A method of making a glass lenticular array is provided. The method comprises: heating a sheet of glass, the sheet of glass comprising contact regions located thereupon in substantially parallel linear rows; and deforming the heated sheet of glass by contacting the contact regions with a forming body so as to form a plurality of cylindrical lenses in the heated sheet of glass, the plurality of cylindrical lenses arranged in substantially parallel rows with depressed regions between adjacent cylindrical lenses. The depressed regions are formed at the contact regions while apex regions of the cylindrical lenses are kept untouched during the step of deforming.

### TECHNICAL FIELD

The present disclosure relates to autostereoscopic displays and, more particularly, glass lenticulars for autostereoscopic displays.

### BACKGROUND

A lenticular array is used in an autostereoscopic display to create an impression of three-dimension (3-D) to the viewer. The lenticular array is made up of a plurality of cylindrical lenses that create views of the image that are different for each eye of the viewer when the lenticular array is placed in front of a pixelated image source. The lenticular array needs to be manufactured with micron-scale accuracy in order to properly locate the cylindrical lenses about the pixels of the image source.

One manner of forming the lenticular array, i.e., bonding cylindrical lenticules to a support where the lenticules and the support are made of different materials, can suffer from lack of accuracy because attachment of numerous lenticules to the plate can result in more defects. Thus, there is a need for alternative means of manufacturing the lenticular array.

### SUMMARY

Numerous methods and materials may be used to fabricate complex, precision optical elements. Because a great majority of conventional machining processes for the manufacture of optical components are unsuited for producing very small features, components having surface features or dimensions as small as 500 μm or smaller typically can be fabricated only through a few methods of limited applicability. Fabrication of microstructured surfaces using polymers have leveraged off of processes developed by the semiconductor industry for making integrated circuits. Using photolithography and ion etching techniques, some have created submillimeter surface features. These methods, however, are not conducive to large scale manufacturing. The process time needed to etch a microstructure in proportionately dependent on the required total depth of the microstructure. Moreover, the methods are typically expensive and etching processes can create rough surfaces. A smooth concave or convex profile, or true prismatic profiles, cannot be readily achieved using either of the two aforementioned techniques.

Molding or hot embossing of plastic or glass materials, on the other hand, can form submillimeter-sized features. Plastics can conform to molds and reproduce faithfully intricate designs or fine microstructures. Unfortunately, plastic materials are not ideal since they suffer from several shortcomings. Plastic materials are often not sufficiently robust to withstand environmental degradation over time. First, they exhibit large coefficients of thermal expansion and limited mechanical properties. Plastic devices often cannot withstand humidity or high temperatures for long periods of time. Both the volume and refractive indices of plastics vary substantially with changes in temperature, thereby limiting the temperature range over which they may be useful. Since plastics for optical applications are available in a limited range of dispersion and refractive index, plastics provide only a restricted transmission range. Hence, their usefulness even within a restricted transmission bandwidth is limited by the tendency to accumulate internal stresses, a condition that results in distortion of transmitted light during use. In addition, many plastics can scratch easily and are prone to yellowing or develop haze and birefringence. Application of abrasion-resistant and anti-reflective coatings, unfortunately, still has not fully solved these flaws. Finally, many chemical and environmental agents degrade plastics, which makes them difficult to clean effectively.

In comparison, glass possesses properties that make it a better class of optical material over plastics. Glass normally does not suffer from the material shortcomings of plastics, and it can better withstand detrimental environmental or operational conditions.

Precision optical elements of glass are customarily produced by one of two complex, multi-step processes. In the first, a glass batch is melted at high temperatures and the melt is formed into a glass body or gob having a controlled and homogeneous refractive index. Thereafter, the glass body may be reformed using pressing techniques to yield a shape approximating the desired final article. The surface quality and finish of the body at this stage of production, however, are not adequate for image forming optics. The rough article is annealed to develop the proper refractive index and the surface features improved by conventional grinding and polishing methods. In the second method, the glass melt is formed into a bulk body that is immediately annealed, cut and ground into articles of the desired configuration. Both of these methods have their limitations. On one hand, grinding and polishing are restricted to producing relatively simple shapes, such as flats, spheres and parabolas. Other shapes and general aspheric surfaces are difficult to grind and complicated to polish. On the other hand, conventional techniques for hot pressing of glass do not provide the exacting surface features and qualities required for clear image formation. The presence of chill wrinkles in the surface and surface figure deviations constitute chronic afflictions.

The molding of glass traditionally has presented a number of other problems. Generally, to mold glass one must use high temperatures to make the glass conform or flow into a requisite profile defined by the mold. First, at such relatively high temperatures that produce molten glass, the glass becomes highly chemically reactive. Due to this reactivity of molten glass, highly refractory molds with inert contact surfaces are required. Some materials used to fabricate molds include silicon carbide, silicon nitride or other ceramic materials, or intermetallic materials such as iron aluminides, or hard materials such as tungsten. In many cases such materials do not present sufficient surface smoothness or optical quality for making satisfactory optical surface finishes. The potential for air or gas bubbles to be entrapped in the molded article is another drawback of high temperature molding. If captured within the glass, gas bubbles tend to degrade the optical properties of the article. The bubbles distort images and generally disrupt optical transmission. Even at high temperatures, hot-glass molding cannot create efficiently high-frequency submillimeter microstructures on the surface of the glass.

Accordingly, embodiments described herein address some of these shortcomings of conventional glass forming techniques. In one example aspect, a method of making a glass lenticular array is provided. The method comprises the steps of: heating a sheet of glass to a deformable state; and contacting the heated sheet of glass with a forming body, the forming body comprising a plurality of elongate projections protruding therefrom, the plurality of elongate projections arranged substantially parallel to one another and at substantially equal distances apart, each of the elongate projections comprising a distal end and a root end. The step of contacting forms a plurality of cylindrical lenses in the heated sheet of glass arranged in substantially parallel rows with a depressed region between two adjacent rows. During the step of contacting, the heated sheet of glass contacts the distal ends of the elongate projections but does not contact the root ends.

In another example aspect, a forming body for forming a lenticular array on a sheet of glass is provided. The forming body comprises a plurality of elongate projections protruding therefrom. The plurality of projections is arranged substantially parallel to one another and at substantially equal distances apart. Each of the elongate projections comprises a distal end and a root end. The root ends are configured not to contact the sheet of glass where at least one of the forming body and the sheet of glass are brought into contact such that the distal ends deform the sheet of glass so as to form cylindrical lenses arranged in substantially parallel rows with a depressed region between two adjacent rows.

In yet another example aspect, a method of making a glass lenticular array is provided. The method comprises: heating a sheet of glass, the sheet of glass comprising contact regions located thereupon in substantially parallel linear rows; and deforming the heated sheet of glass by applying force on the contact regions so as to form a plurality of cylindrical lenses in the heated sheet of glass, the plurality of cylindrical lenses arranged in substantially parallel rows with a depression region between two adjacent cylindrical lenses. The depressed regions are formed at the contact regions while at least apex regions of the cylindrical lenses are kept untouched during the step of deforming.

In yet another example aspect, a glass lenticular array comprises a base portion and rows of cylindrical lenses protruding from the base portion. The cylindrical lenses and the base portion are formed as a single-piece. The lenses are spaced apart from one another by a depressed region between two adjacent cylindrical lenses. Each of the depressed regions is covered with dark material.

### BRIEF DESCRIPTION OF THE DRAWINGS

These and other aspects are better understood when the following detailed description is read with reference to the accompanying drawings, in which:

FIG. 1 is an example embodiment of a glass lenticular array;

FIG. 2 is a first example embodiment of a forming body for making a glass lenticular array;

FIG. 3 is a first example arrangement of the forming body and a sheet of glass for making the glass lenticular array;

FIG. 4 is a close-up view of a distal end of an elongate projection on the forming body;

FIG. 5 is a second example arrangement of the forming body and a sheet of glass for making the glass lenticular array;

FIG. 6 is a third example arrangement of the forming body and a sheet of glass for making the glass lenticular array;

FIG. 7 is a second example embodiment of the forming body with a sheet of glass;

FIG. 8 is a third example embodiment of the forming body with a sheet of glass;

FIG. 9 is a fourth example embodiment of the forming body with a sheet of glass;

FIG. 10 is a close-up view of a depressed region of the glass lenticular array;

FIG. 11 is a first example method of forming the elongate projections on the forming body;

FIG. 12 is a schematic view of a first example tool for shaping the forming body;

FIG. 13 is a schematic view of a second example tool for shaping the forming body;

FIG. 14 is a second example method of forming the elongate projections on the forming body; and

FIG. 15 is an example method of heating the sheet of glass.

### DETAILED DESCRIPTION

Examples will now be described more fully hereinafter with reference to the accompanying drawings in which example embodiments are shown. Whenever possible, the same reference numerals are used throughout the drawings to refer to the same or like parts. However, aspects may be embodied in many different forms and should not be construed as limited to the embodiments set forth herein.

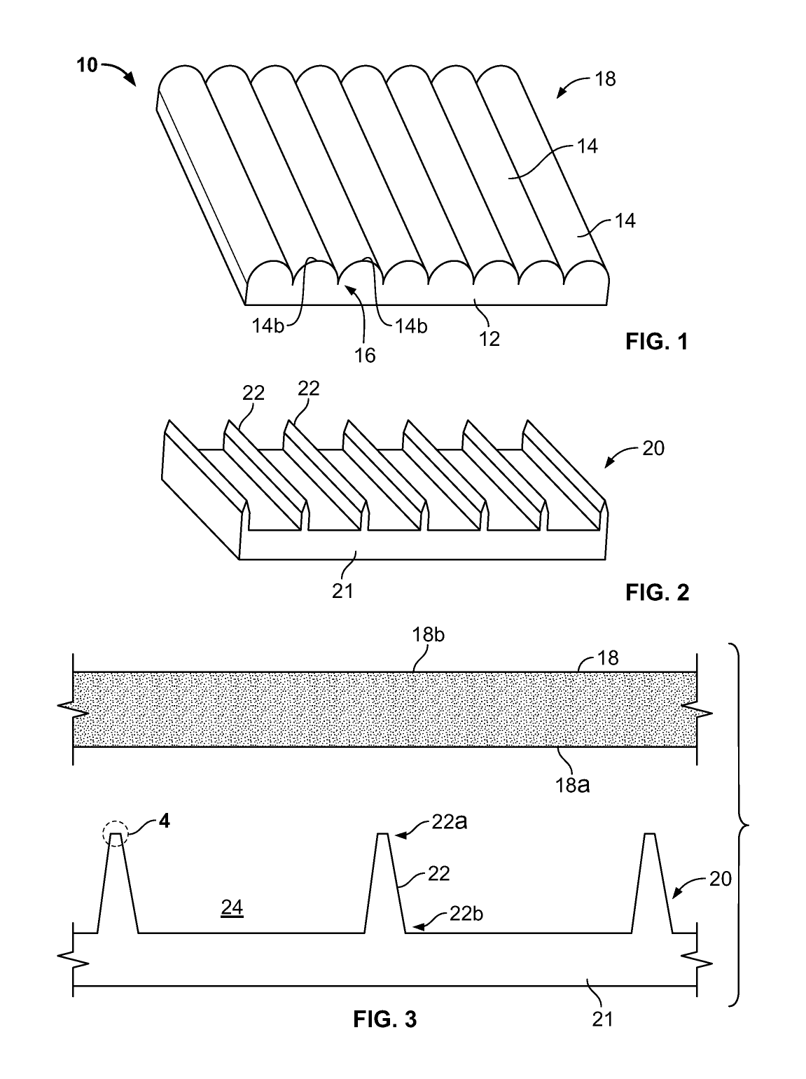

Referring now to FIG. 1, an example embodiment of a glass lenticular array 10 is shown. The array 10 may include a base portion 12 with a plurality of cylindrical lenses 14 that protrude from one side of the base portion 12 and preferably form a single piece with the base portion 12. The cross-sections of the cylindrical lenses 14 may be shaped to have a convex side, such as a semi-circle. Thus, as used herein, reference to a cylindrical lens may denote a lens comprising only a portion of a cylinder. The cylindrical lenses 14 are arranged in rows that may be substantially parallel to one another. As shown in FIGS. 1 and 10, each cylindrical lens 14 may include an apex region 14b and each pair of two adjacent cylindrical lenses 14 may be spaced apart from one another by a depressed region 16.

The lenticular array 10 may be formed from a sheet of glass 18 produced by a variety of methods. For example, the glass sheet may be produced by a fusion down draw process, a float process, a slot draw process, or any other known or future method of making a glass sheet. Glass sheet 18 may be any suitable thickness, but for television or hand-held device applications, a thickness of the glass sheet is preferably equal to or less than 1100 μm, equal to or less than 700 μm, equal to or less than 500 μm, equal to or less than 300 μm and in some embodiments equal to or less than about 100 μm. The glass sheet may be formed from a glass of any suitable composition capable of being molded.

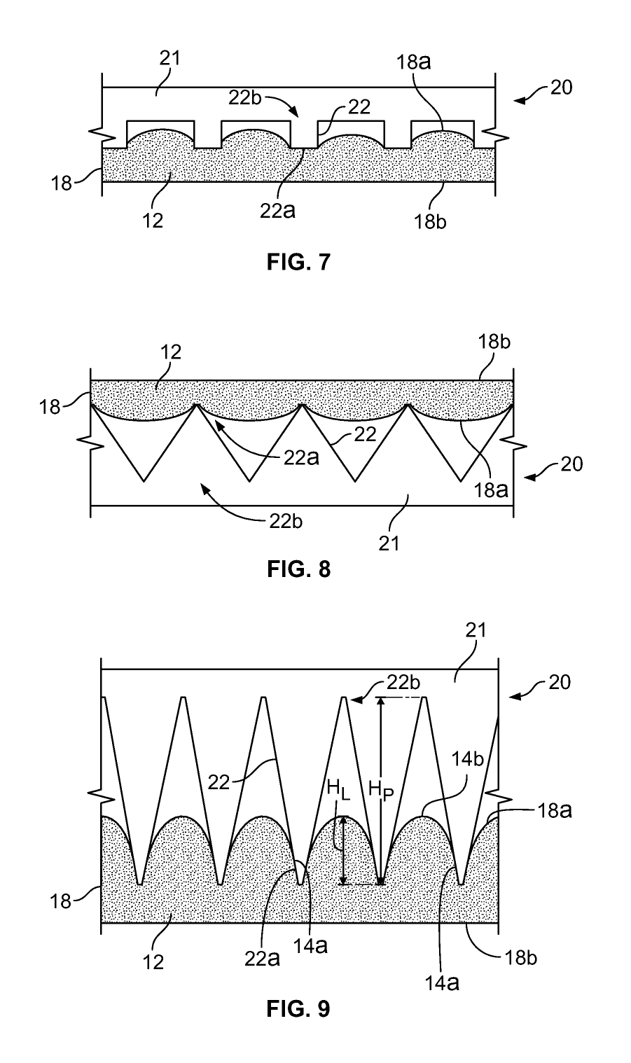

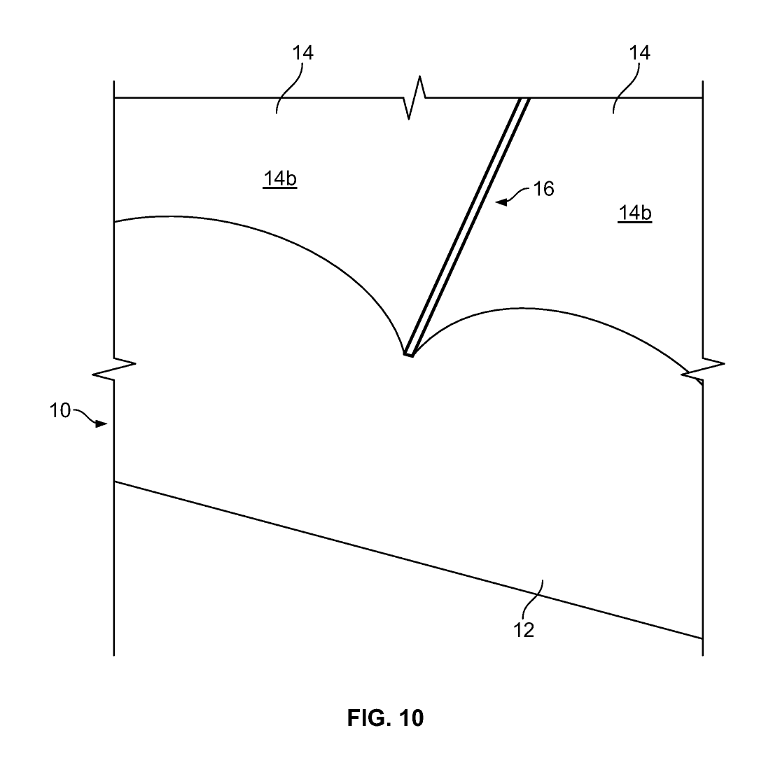

As shown by FIGS. 2 and 3, forming the lenticular array 10 from the sheet of glass 18 involves the use of a forming body 20 comprising a base member 21 and a plurality of elongate projections 22. The plurality of elongate projections 22, in one example, may be arranged as thin walls running substantially parallel to one another and/or at substantially equal distances apart. Each of the elongate projections 22 includes a distal end 22a projecting away from the base member 21 and a root end 22b by which the projection is joined to the base member 21. If the arrangement of the elongate projections 22 are substantially parallel to one another, the cylindrical lenses 14 will likewise be formed in substantially parallel rows as shown in FIG. 1. The spaces between the elongate projections 22 form trenches 24 whose shape depends in part on the shape of the projections 22. While the elongate projections 22 may be substantially identical in shape, such shapes may vary as shown in FIGS. 2-3 and 7-9. A cross-sectional shape of the elongate projections 22 may be polygonal (e.g., pentagonal (FIG. 2), trapezoidal (FIG. 3), rectangular (FIG. 7), triangular (FIGS. 8-9)), or have other polygonal shapes and/or shapes including one or more curvilinear sides, etc. Example elongate projections may include a cross-sectional shape with a broader root end such as in FIGS. 3 and 8-9 to provide enhanced structural rigidity. In further examples, the shape of the elongate projections 22 may be designed to achieve the desired shape of the cylindrical lenses.

As shown in FIGS. 3 and 5-6, the lenticular array 10 may be formed by contacting the sheet of glass 18 with the distal ends 22a of the elongate projections 22 and thereby deforming the sheet of glass 18 with force applied through the distal ends 22a. In some examples, the force may be applied passively by gravity, or actively as described further below. Deformation of the sheet of glass 18 is made possible by heat applied thereto. Heating of the sheet of glass 18 may be conducted before or while the sheet 18 makes contact with the distal ends 22a. FIG. 15 shows an example embodiment of a device 26 with which the sheet of glass 18 can be heated (e.g., a furnace). The sheet of glass 18 may be heated in an isolated manner or may be heated while in contact with the distal ends 22a as shown in FIGS. 5-9. An alternative embodiment to the device 26 shown in FIG. 15 may be a furnace that includes on the inside a conveyor belt along which a plurality of forming bodies 20 in contact with sheets of glass 18 are transported in a sequential and/or continuous process. The device 26 is configured so that operating conditions such as the force applied against the forming body and/or the sheet of glass, the temperature within the device, the rate at which the temperature is raised or lowered, or the duration over which a temperature is maintained, can be controlled as needed. In some embodiments, a specific gas or mixture of gases may be controlled within the device 26. For example, if articles employed during the processing steps are susceptible to combustion at the processing temperatures used, a non-oxidizing (e.g. inert) atmosphere may be employed.

It should be noted that the forming body 20 may be isothermally heated so that the forming body is at a uniform temperature. Preferably, the temperature of the forming body is substantially equal to the temperature of the heated sheet of glass. Accordingly, in some embodiments, the sheet of glass and the forming body are heated together in the furnace and the contacting occurs within the furnace.

It should also be noted that a variety of arrangements for contacting the sheet of glass 18 with the forming body 20 is possible. In the example embodiments of FIGS. 3, 5, 6, and 8, the forming body 20 is located below the sheet of glass 18. From the state shown in FIG. 3, at least one of the sheets of glass 18 and the forming body 20 is moved toward one another such that the distal ends 22a are forced against a proximal surface 18a of the sheet of glass 18. In one example embodiment of the configuration of FIG. 3, the sheet of glass 18 may be placed to lie on top of the forming body 20 such that the weight of the sheet of glass 18 acts as a force that pushes the sheet of glass 18 downward against the distal ends. Forcing the distal ends against the heated sheet of glass creates a sagging effect by which the glass begins to project or flow into the trenches 24. It may be necessary to maintain the forming body 20 and the sheet of glass 18 in contact for an extended period of time to form the lenticular array 10. Moreover, as shown in FIG. 5, a weight block 28 may be placed on a distal surface 18b of the sheet of glass 18 thereby creating an additional force pushing the sheet of glass 18 further downward against the distal ends 22a of the forming body 20. The weight block 28 may have a variety of mass and may be made of material that does not adhere to heated glass. Polished graphite may suffice in case of low process temperatures.

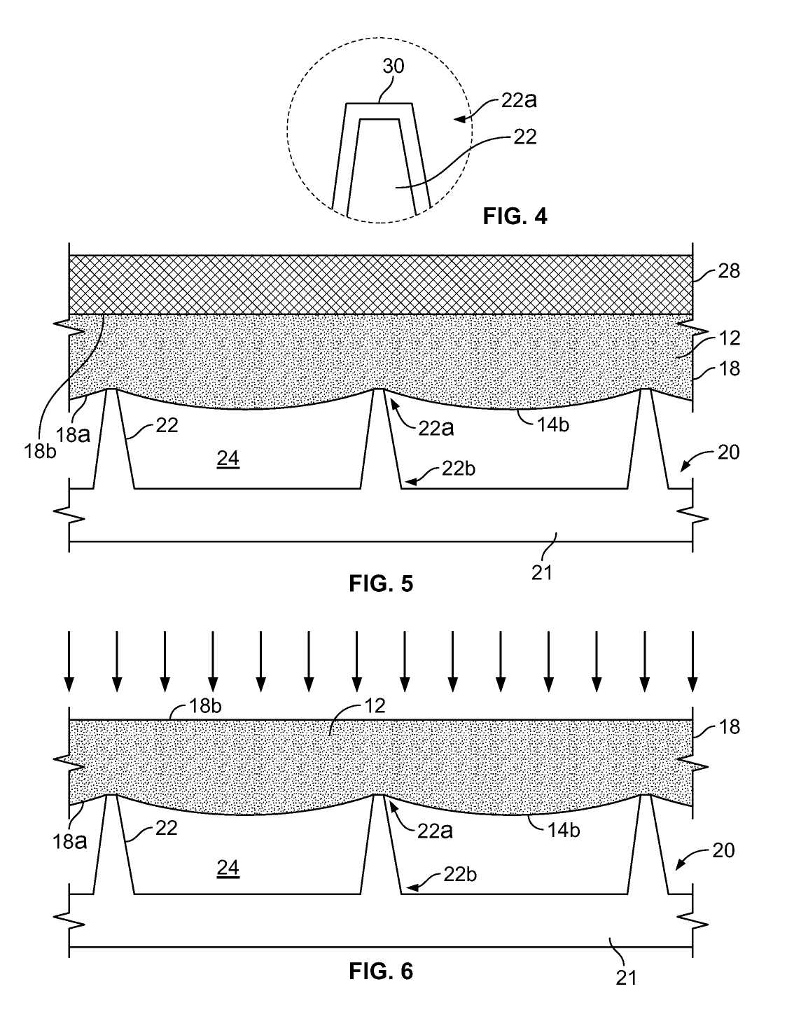

FIG. 6 differs from FIG. 4 in that the sheet of glass 18 is forced against the distal ends 22a in a non-contact manner, for example, by applying gas pressure on the distal surface 18b of the sheet of glass 18 (as indicated by arrows) instead of using a solid element such as the weight block 28. Alternatively, it is also possible to apply gas pressure on a rear side of the weight block 28 placed on top of the sheet of glass 18. In alternative embodiments, the sheet of glass 18 or the forming body 20 may be moved and held by manipulating devices (e.g., robot arms) such that the effect of forces acting between the sheet of glass 18 and the forming body 20, such as gravitational forces, are reduced, enhanced or even nullified. Another way of applying force may be to use a roller against the distal surface 18b of the sheet of glass 18 or the forming body 20.

It may also be possible to make a lenticular array 10 having cylindrical lenses 14 on both sides. In order to make such a lenticular array 10, a sheet of glass 18 may be positioned between two forming bodies 20 that are oriented such that the distal ends 22a of one forming body 20 point at the distal ends 22a of another forming body.

In the example embodiments of FIGS. 7 and 9, the forming body 20 is located above the sheet of glass 18. At least one of the sheets of glass 18 and the forming body 20 is moved toward the other such that the distal ends 22a of elongate projections 22 push against the proximal surface 18a of the sheet of glass 18. In this configuration, the weight of the forming body 20 may be sufficient to force the distal ends 22a downward against the sheet of glass 18. Moreover, the sheet of glass 18 may be supported from below by a structure that preferably does not adhere to the glass. In alternative embodiments, the sheet of glass 18 or the forming body 20 may be moved and/or held by manipulating devices (e.g., robot arms) such that the effect of forces acting between the sheet of glass and the forming body, such as gravitational forces, are enhanced, reduced or even nullified. Still further, a weight block 28, rollers, or other force mechanisms such as hydraulic or pneumatic presses may be used to apply a force to the forming body 20, the sheet of glass 18, or both to achieve the desired lenticular array characteristics.

Particular glass compositions may adhere to the material of the forming body. To reduce adherence of the distal ends 22a to the sheet of glass 18, the forming body 20 as a whole, the elongate projections 22 or the distal ends 22a thereof can be coated with a coating or film 30 (FIG. 4) composed of a substance such as but not limited to boron nitride, titanium aluminum nitride, or carbon soot. Moreover, the weight block 28 used in FIG. 5, or other force mechanism, may be coated with a substance that reduces adherence to the distal surface 18b of the sheet of glass 18. In some embodiments the sheet of glass 18 may be coated with a substance for reducing adherence with the forming body 20 during the forming operation. For example, the sheet of glass may be coated with carbon soot.

In FIGS. 3 and 5-9, the distal ends 22a of the elongate projections 22 act as contacting elements configured to touch contact regions on the sheet of glass 18. Contrastingly, the root ends 22b of the projections 22 are configured not to contact the sheet of glass 18 when at least the sheet of glass 18 or the forming body 20 are brought into contact with one another. That is, the depressed regions 16 are formed at the contact regions of the sheet of glass 18 through the application of force by the distal ends 22a (FIG. 10). Parts of the sheet of glass 18 that do not contact the forming body 20 in between the projections 22 deform and gradually become outwardly projected to form the cylindrical lenses 14. As shown in FIG. 9, in some examples, it is possible for some of the lateral regions 14a of the cylindrical lenses 14 to come into contact with the distal ends 22a. Preferably, the curved surface of a cylindrical lens 14, including the apex regions 14b, does not contact the interior surfaces of the trench and is kept untouched by the projections 22. To with, unlike conventional molding processes wherein the glass fills a cavity and is conformed to the interior surfaces of the cavity to form the lens shape, according to the present embodiment, the portion of the sheet of glass forming the lens is not conformed to the surfaces of a cavity (i.e. trench 24) to attain the shape of the lens.

Once the cylindrical lenses 14 are shaped, a material configured to reduce scattering of light that may be caused by any imprints left by the distal ends 22a, and improve contrast, can be applied to the depressed regions 16. The applied material may be dark (e.g., black, opaque or the like). For example, black pigment particles suspended in a dilute solvent may be coated on the lenticular such that the particles settle by gravity in the depressed regions 16. Alternatively, a polymer selected to match the refractive index of the glass forming the cylindrical material may be used instead of the dark material, wherein the refractive index-matched polymer material is applied to the front surface of the lenticular array in the depressed regions 16 formed by contact with projections 22.

One way to keep the curved surface of the cylindrical lenses 14 from contacting the forming body 20 is to dimension the height of the elongate projections 22 to be sufficiently greater than the desired height of the cylindrical lenses 14. As shown in FIG. 9, the height H_{P} of the elongate projections 22 is defined as the distance from the root end 22b to the distal end 22a in a direction normal to the plane of the base member 21 while the height H_{L} of the lenses 14 is defined as the distance from the depressed regions 16 to the apex regions 14b of the lenses 14 in a direction normal to the plane of the base portion 12. For example, the average height of the elongate projections 22 may be substantially greater than the average height of the lenses 14. In some embodiments, an average height H_{L} of the cylindrical lenses is equal to or less than 400 μm, preferably equal to or less than 300 μm, preferably equal to or less than 200 μm and more preferably equal to or less than 100 μm. In other embodiments, an average height of the cylindrical lenses is equal to or less than 75 μm, equal to or less than or equal to 50 μm, or even equal to or less than 10 μm. In some embodiments a maximum variation in H_{L} is equal to or less than about 20 μm, preferably equal to or less than 15 μm and more preferably equal to or less than about 10 μm.

Although the peak-to-peak (apex-to-apex) pitch of the lenticular array may be formed to a value suitable for a specific application, for certain display applications the average peak-to-peak pitch between adjacent cylindrical lenses is preferably equal to or less than 1000 μm, more preferably equal to or less than 600 μm. However, for other applications where pixel sizes of the display are very large, the pitch may be as large as 10 mm. In contrast, a minimum pitch may in some instances be as small as 150 μm. Thus, the pitch may range from about 150 μm to about 10 mm. Preferably, the variation in pitch does not exceed about ±10 μm.

The forming body 20 is preferably made of a material that can withstand the temperatures in which the glass is processed without significant dimensional changes occurring as the forming body 20 varies between the processing temperature and room temperature. For example, the viscosity of the sheet of glass during processing is preferably at least equal to or greater than the annealing viscosity of approximately 10¹³ poise, so the forming body should be capable of withstanding a temperature that equates to the annealing viscosity for the particular glass sheet being processed. In one example, the coefficient of thermal expansion of the forming body 20 may be different from that of glass. For example, the coefficient of thermal expansion of the forming body 20 may be larger or smaller than the coefficient of thermal expansion of the sheet of glass 18, for example, by at least 10×10⁻⁷ m/m ° C. In some examples, the difference in coefficients of thermal expansion between the forming body and the glass sheet may be useful in ensuring the forming body separates from the lenticular array. Furthermore, the forming body 20 can be constructed from a material capable of withstanding temperatures greater than an annealing point of the sheet of glass. Materials satisfying one or more of these criteria may be graphite, glassy carbon, a nickel-chromium alloy, various types of steel, or the like. In preferred embodiments, the forming body may be formed from a plate of austenitic nickel chromium-based alloy such as Inconel. Inconel is particularly capable of withstanding the high temperatures involved in processing the sheet of glass without corrosion or significant wear or damage from use.

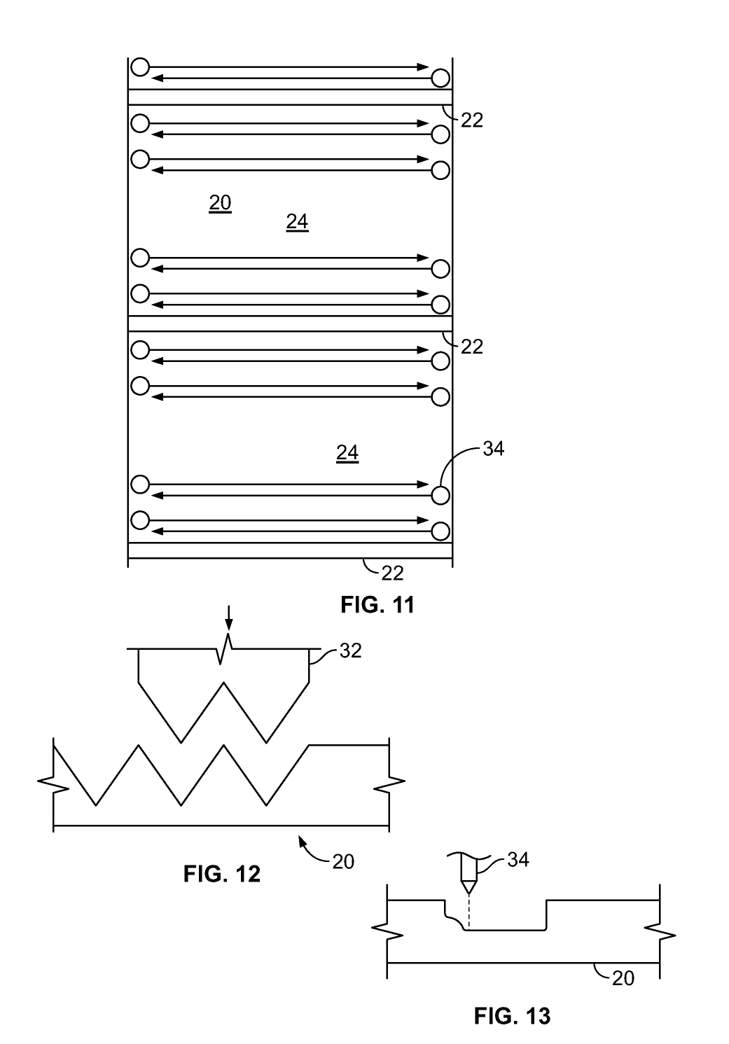

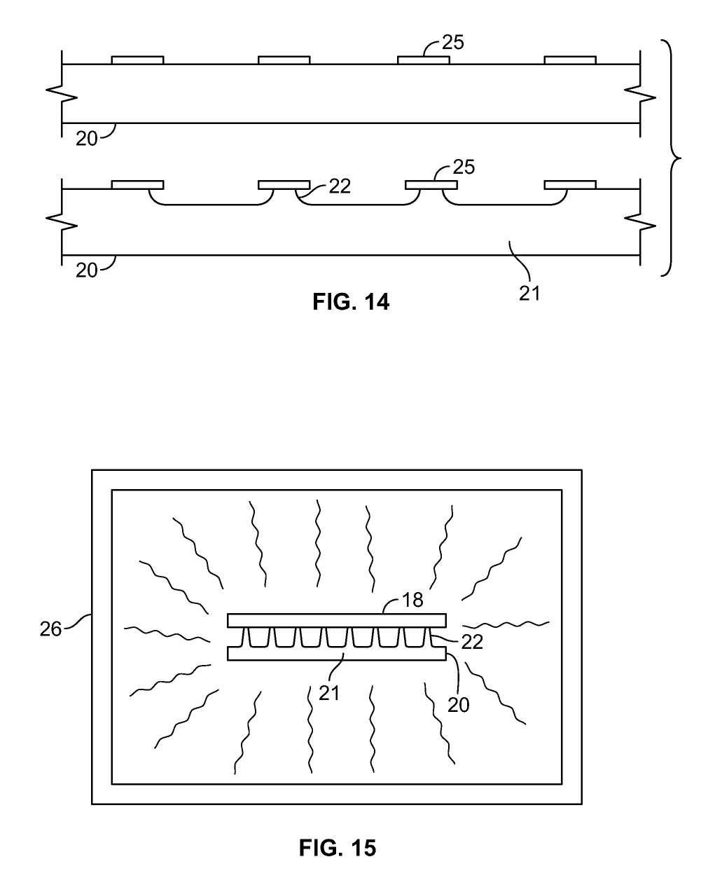

The trenches 24 between the elongate projections 22 may be formed on the forming body 20 by a variety of methods such as plunge electric discharge machining, as shown in FIG. 12. In plunge electric discharge machining an electric discharge device 32 (e.g. an electrode) having a predetermined contour, such as a repeating contour, is moved or “plunged” toward the forming body 20. Electric discharge between the surface of the device and a workpiece forms the contours of the forming body 20 by preferentially eroding portions of the workpiece. Repeated plunging of the device may be used to fully form the forming body from the workpiece. As shown in FIG. 13, laser ablation (e.g., pico laser drilling) may also be used to form the forming body 20. As shown in FIGS. 11 and 13, a laser beam emitting device 34 may be moved along parallel lines extending between the lateral edges of the forming body 20 (i.e., rastering) or the forming body 20 may be moved about stationary machining devices. The depth of the trenches 24 may be controlled by parameters of the laser such as wavelength, pulse energy, raster speed, etc. or the translation speed of the forming body 20 about the machining devices. Due to the micron scale of the lenses 14, the surfaces of the forming body 20 are machined with tight tolerances to be flat and smooth. Moreover, it is also possible to form the trenches 24 by chemical etching as shown in FIG. 14. For example, in one embodiment forming body 20 can be formed from Inconel (e.g. Inconel 718), such as an Inconel plate, on which a mask material 25 is applied, typically by photolithography methods. A suitable chemical etchant (e.g. ferric chloride) can then be applied to the mask and forming body so that portions of the forming body not covered by the masking material is eroded or dissolved, leaving elongate projections 22. As the etchant etches approximately uniformly on the Inconel plate, material is removed from the plate both in a downward direction into the plate and perpendicular to the surface of the plate, but also in a sidewise direction, roughly parallel with a surface of the plate and undercutting the mask material. For a 30-40 μm sag of the glass (in the instance where the sheet of glass is allowed to sag into the forming body trench), a trough 60 μm deep is sufficient to prevent contact between the apex of the cylindrical lens and the interior surface of the trough. Accordingly, a 60 μm deep etch results in approximately 50 μm to 60 μm of material being removed from the both sides of a wall. Thus, to obtain elongate projections with a 20 μm thickness and an approximately 40 μm trench depth, the mask should be about 100 μm wide, assuming the mask is undercut by approximately 40 μm from each side. These dimensions of course are dependent on the particular design of the desired lenticular array and may therefore vary. Once the forming body has been etched, the residual etchant is washed away and the masking material is removed. In some embodiments the elongate projections, or walls, may be further thinned, at least near the distal ends, by additional machining, such as laser machining. It is preferred that the distal ends be as thin as possible. For example, the distal ends may have a thickness equal to or less than about 5 μm, preferably equal to or less than 3 μm, more preferably equal to or less than 2 μm.

The curvature of the lenses 14 may depend on the type of application for which the lenticular array 10 is used since some applications involve close up viewing of the display while others require far away viewing. A variety of factors can affect the formation or shape of the cylindrical lenses 14. These factors may be the area of the contact regions, the viscosity of the glass sheet at the process temperature, the coefficient of thermal expansion of the glass sheet, the thermal conductivity of the glass sheet, the chemical composition of the glass sheet, the surface roughness of the glass sheet prior to processing, the surface tension of the glass sheet, the process temperature, the force applied to the forming body and/or the glass sheet, the process time, the ramp rate of the temperature, etc. For a given glass composition, a specific curvature of the lenses 14 can be obtained by primarily controlling four factors, i.e., the distance between adjacent elongate projections 22 (the wall or elongate projection pitch), the process temperature (i.e., the temperature of the atmosphere in which the glass 18 is processed), the process pressure (i.e., the force applied by the elongate projections 22 on the glass 18) and process time (i.e., the length of time that the elongate projections 22 are kept in contact with the glass 18). For a given glass composition, it is more difficult to form lenses 14 having large radius of curvature as the process temperature increases. While the process temperature may need to be lowered to form lenses 14 with large radius of curvature, it may instead be necessary to increase the force or to lengthen the process time. Contrastingly, for the same glass composition, at higher process temperatures, lenses 14 with smaller radius of curvature can be formed with smaller process pressure or shorter process time. The combination of process parameters will be dictated by the requirements of the lenticular array, and many combinations to achieve the desired results are possible.

A glass lenticular array 10 may provide the following advantages over a conventional lenticular array with a glass support portion and plastic cylindrical lenses. Glass can reduce the number of processing steps because there would be no step needed to bond the lenticules to the support portion. The glass lenticular array 10 can improve the pitch accuracy of the lenticules relative to the positions of the pixels in the image source because glass compositions can be produced that expand or contract less than typical plastics for a given change in temperature and because for a glass lenticular array the degree of expansion of the glass as a whole and the lenticules will be the same. Glass can also provide good dimensional stability during handling and in use. On the other hand plastic lenticules are more susceptible to stretching and can deform more easily. Glass is often used in products requiring high quality optics and may match well with optical coatings. Glass may provide superior damage resistance due to its hardness and resistance to chemicals and solvents. Properties such as scratch resistance provided by glass may be desired for use in hand-held applications. Glass can also be strengthened through surface chemical hardening, thermal tempering, ion exchange or the like. Glass may also provide better reliability and life because the damage resistance of glass is not diminished with time and glass is less susceptible to degradation due to ultraviolet light, moisture or exposure to low heat. Glass may also provide greater stiffness for a predetermined thickness that enables the position of the optics to be held in a stable position thereby reducing the need of additional structures that might otherwise be needed with plastic. Annealing of glass can deliver stress-free lenses with no retardance or other optical defect likely to disturb polarized light LCD transmission. Molded polymer lens arrays generally suffer from the rapid cooling required for registration and overall geometrical control.

In some aspects, the glass lenticular array 10 according to embodiments described herein can be adhered to a display panel, such as an LCD or organic light emitting diode (OLED) display panel. For example, the glass lenticular array can be adhered to the display panel with a refractive index-matching adhesive such as a suitable epoxy adhesive. The refractive index matching adhesive can be effective to reduce light scattering by the distal surface of the lenticular array. Additionally, it is preferable that the refractive index of the glass lenticular array be substantially the same as the refractive index of the display panel surface to which the lenticular array is adhered to. It is also preferred that if the glass lenticular array is adhered to the glass display panel that the coefficient of thermal expansion of the glass lenticular array be substantially the same as the glass of the display panel to which it is adhered. In other embodiments, the glass lenticular array may be removably attached to the display panel, or to the device comprising the display panel so that the glass lenticular array can be readily removed when not needed.

### Example

In one example fifteen glass lenticular arrays were formed from samples of an aluminoborosilicate glass (Corning Incorporated® Eagle™ XG glass) having a softening temperature of 965° C. and a CTE of approximately 32×10⁻⁷ m/m ° C. over the range from about 0° C. to about 300° C. The sheets of glass had thicknesses of 500 μm and 600 μm, and external (length by width) dimensions of 50 mm×50 mm. A graphite forming body as described supra was placed in a box furnace with the elongate projections facing upward, a sample glass sheet was placed on the forming body in contact with the elongate projections and a weight block was then placed on the glass sheet distal surface. The furnace temperature was raised to a hold temperature, and maintained at the hold temperature for a predetermined hold time as indicated in the Table below. As indicated, the hold temperatures were less than the softening temperature of the sheets of glass, ranging from about 800° C. to about 950° C. The furnace was filed with a nitrogen atmosphere to prevent oxidation of the graphite forming body. At the conclusion of the hold time the furnace temperature was reduced and the forming body, glass sheet sample and weight block were removed. Lenticular lens heights ranged from 32 μm to 396 μm.

TABLE

| | Sample | | Hold | | |
|---|---|---|---|---|---|
| Sample | Thickness | Weight block | Temp. | Hold time | Lens Height |
| # | (μm) | Mass (gm) | (° C.) | (hr.) | (μm) |
| 1 | 600 | 434 | 875 | 1 | 74 |
| 2 | 600 | 434 | 900 | 1 | 42.3 |
| 3 | 600 | 434 | 925 | 1 | 184 |
| 4 | 600 | 434 | 950 | 1 | 396 |
| 5 | 600 | 1021 | 850 | 8 | 220 |
| 6 | 500 | 1021 | 875 | 8 | 203 |
| 7 | 500 | 1021 | 900 | 8 | 197 |
| 8 | 500 | 1021 | 850 | 1 | 32 |
| 9 | 500 | 1021 | 800 | 24 | 48 |
| 10 | 500 | 434 | 900 | 4 | 146 |
| 11 | 500 | 434 | 925 | 2 | 301 |
| 12 | 500 | 434 | 900 | 1 | 61 |
| 13 | 500 | 434 | 900 | 0.5 | 51 |
| 14 | 500 | 434 | 900 | 0.2 | 79 |
| 15 | 500 | 1585 | 900 | 0.2 | 123 |

The data from the Table show that varying lens heights can be obtained by varying the hold (process) temperature, the length of time the forming body is in contact with the sheet of glass and the force applied to the sheet of glass (or alternatively the forming body). It should be apparent that other glass compositions having different thermal characteristics can be accommodated by making suitable adjustments to the process temperature, hold time and force.

It will be apparent to those skilled in the art that various modifications and variations can be made without departing from the spirit and scope of the claimed invention.

What is claimed is:

1. A method of making a glass lenticular array, the method comprising:
heating a sheet of glass;
heating a forming body;
deforming the heated sheet of glass by contacting heated sheet of glass with the heated forming body to form a plurality of cylindrical lenses in the heated sheet of glass, the plurality of cylindrical lenses arranged in substantially parallel rows with depressed regions between adjacent cylindrical lenses; and
wherein apex regions of the cylindrical lenses are untouched during the step of deforming.

2. The method of claim 1, wherein a temperature of the heated forming body is substantially the same as a temperature of the heated sheet of glass.

3. The method of claim 1, further comprising the step of applying dark material on the depressed regions after the step of deforming.

4. The method of claim 1, further comprising the step of applying a polymer material on the depressed regions after the step of deforming, the polymer material having an index of refraction that matches a refractive index of the sheet of glass.

5. The method of claim 1, wherein at least one of the forming body and the sheet of glass is moved in a non-contact manner during the step of deforming.

6. The method of claim 1, wherein each cylindrical lens comprises a height H_{L} defined as a distance from a depressed region adjacent to the cylindrical lens to the apex of the lens in a direction normal to a plane of a base portion of the lenticular array, and wherein an average height of the plurality of cylindrical lenses is equal to or less than 1500 μm.

7. The method of claim 6, wherein the forming body comprises a plurality of elongate projections extending from a base member, each elongate projection comprising a root end connected with the base member and an opposite distal end, each elongate projection further comprising a height Hp defined as a distance from the root end of the elongate projection to the distal end in a direction normal to a plane of the base member, and wherein an average height of the plurality of elongate projections is greater than the average height of the plurality of cylindrical lenses.

8. A method of making a glass lenticular array, the method comprising the steps of:
(I) heating a sheet of glass to a deformable state; and
(II) contacting the heated sheet of glass with a forming body, the forming body comprising a base member and a plurality of elongate projections protruding therefrom, the plurality of projections arranged substantially parallel to one another and at substantially equal distances apart, each of the elongate projections comprising a distal end and a root end, wherein the step of contacting forms a plurality of cylindrical lenses in the heated sheet of glass arranged in substantially parallel rows with a depressed region between two adjacent rows; and
wherein during the step of contacting, the heated sheet of glass contacts the distal ends of the elongate projections but does not contact the root ends.

9. The method of claim 8, wherein each cylindrical lens comprises a height H_{L} defined as a distance from a depressed region adjacent to the cylindrical lens to an apex of the cylindrical lens in a direction normal to a plane of the glass lenticular array, and each elongate projection comprises a height Hp defined as a distance from the root end of the elongate projection to the distal end in a direction normal to a plane of the base member, and wherein an average height of the plurality of elongate projections is greater than an average height of the plurality of cylindrical lenses.

10. The method of claim 9, wherein the average height of the plurality of cylindrical lenses is equal to or less than 1500 μm.

11. The method of claim 8, further comprising the step of applying dark material on the depressed regions after the step of contacting.

12. The method of claim 8, further comprising the step of applying a polymer material on the depressed regions after the step of deforming, the polymer material having an index of refraction that matches a refractive index of the sheet of glass.

13. The method of claim 8, wherein the forming body is formed from a nickel chromium-based alloy.

14. The method of claim 8, wherein a coefficient of thermal expansion of the forming body differs from a coefficient of thermal expansion of the sheet of glass by at least 1×10⁻⁶ m/m ° C.

15. A forming body for forming a lenticular array on a sheet of glass, the forming body comprising:
a base member and a plurality of elongate projections protruding therefrom, the plurality of projections arranged as substantially parallel walls, each of the elongate projections comprising a distal end and a root end, each elongate projection further comprising a height Hp defined as a distance from the root end of the elongate projection to the distal end in a direction normal to a plane of the base member; and
wherein a thickness of the distal ends is equal to or less than 5 μm.

16. The forming body of claim 14, wherein the forming body is made of graphite.

17. The forming body of claim 14, wherein the forming body comprises a nickel-chromium alloy.

18. The forming body of claim 14, wherein the forming body comprises titanium aluminum nitride.

19. The forming body of claim 14, wherein the elongate projections comprise a substantially triangular cross-section.

20. A glass lenticular array comprising:
a base portion; and
rows of cylindrical lenses protruding from the base portion, the cylindrical lenses and the base portion formed as a single-piece, the lenses spaced apart from one another by depressed regions between adjacent cylindrical lenses, each of the depressed regions covered with dark material.
